(19) United States
(12) Patent Application Publication
(10) Pub. No.: US 2007/0121441 A1
(43) Pub. Date: May 31, 2007

(54) Optical disk recording/reproducing apparatus and seek control method thereof

(76) Inventors: Takeyoshi Kataoka, Yokahama (JP); Mitsuru Harai, Tokyo (JP); Nobuhiro Takeda, Tokyo (JP); Tsuyoshi Toda, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/500,443

(22) Filed: Aug. 8, 2006

(30) Foreign Application Priority Data
Nov. 30, 2005 (JP) 2005-345499

(51) Int. Cl. G11B 7/00

(52) U.S. Cl. 369/44.28

(57) ABSTRACT

Within a seek control method for moving an optical spot onto an arbitrary track, by moving the optical spot into a radial direction of an optical information recording medium, which is formed with lands and grooves, spirally, on an information recording surface thereof, calculation is made on time from staring of seek operation up to completion of pulling the optical spot onto a target track, calculating is made an amount of rotation of the optical information recording medium within that time, which is calculated in the above, determination is made on whether the pulling operation can be conducted or not within a pull-in escape region on a land/groove exchange portion of a tack on the information recording surface of the optical information recording medium, upon the amount of rotation which is calculated in the above, and a starting position of the pulling operation is changed so that the pulling operation can be executed escaping from said pulling escape region, upon basis of result of the determination, thereby achieving the seek operation, with stability and high-speed in timing of conducting tracking servo, also for the optical disk forming the lands and the grooves on the recording surface thereof.

### BACKGROUND OF THE INVENTION

The present invention relates to an optical disk recording/reproducing apparatus and also a seek control method thereof, for enabling to record/reproduce information onto/from an optical disk forming lands and grooves on the recording surface thereof, and in particular, it relates to an optical disk recording/reproducing apparatus and also a seek control method thereof, for conducting a seek operation of moving an optical spot onto a desired track through shifting or moving it in a radial direction of the disk in such the apparatus.

An optical disk of being so-called a disc-like optical information recording medium, such as, CD or DVD, etc., for example, representatively, is widely used, as an information recording medium of non-contact, a large memory capacity and a low cost, and also of enabling data access at high speed, for example, for the purpose of recording/reproducing digital audio data and/or digital video data, and further as a data recording medium for use in a personal computer. In particular, in recent years, so-called a re-writable optical disk is also used widely, such as, DVD-RAM (Digital Versatile Disc of Random Access Memory Type), for example.

As such DVD-RAM disk is applied a medium therein, of so-called a phase-change type, for example, on the recording layer of which overwriting can be made, and also for the purpose of increasing the recording capacity thereof, recording/reproducing can be made onto, not only the grooves, but also the lands defined between the grooves; i.e., so-called a single track format is applied therein, with which the land and the groove appears, alternately, per one (1) round of rotation of the disk.

On the other hand, within an optical disk recording/reproducing apparatus for conducting recording or reproducing onto/from such the optical information medium, an acceleration pulse is generated for moving an optical spot from an optical pickup into the radial direction of the disk, in other words, crossing or traversing tracks towards an objective or target track, when changing the track to be conducted recording or reproducing thereon/from, thereby moving an optical pickup including an objective lens therein; i.e., so-called a seek control. However, in general, such the seek control is composed of the following three (3) stages: i.e., an acceleration stage of applying the acceleration pulse onto a driving mechanism of the optical pickup; a constant speed stage of keeping moving velocity of the optical pickup at a desired value; and further a deceleration stage of applying a deceleration pulse so that the moving velocity of the optical pickup comes down to be near to zero (0) at the target track. And, after completing of the seek control, a track following control is carried out, again, for bringing the optical spot of the optical pickup to follow the track, through a tracking servo system, within the optical disk recording/reproducing apparatus, and thereby conducting recording/reproducing on the target track.

However, in the following Patent Document 1 are pointed out the following drawbacks; i.e., within the optical disk apparatus for driving the optical disk, such as DVD-RAM, for example, it is necessary to carry out the process for drawing or pulling the optical spot after the seek operation because of importance of increasing a seek performance for seeking the track targeted, but such pulling process depends on a sensitivity of an actuator of the lens system, therefore there is an afraid of brining about a failure of pulling operation, such as, so-called “stray of tracking”, in case when it is suddenly changed into the tracking servo operation in the vicinity of the target track, and that the conventional method, such as, the “hysteresis pulling” cannot be applied onto such the DVD-RAM disk. Further, in this Patent Document 1, it is also pointed out that noises are generated in the tracking error (i.e., TE) signal at CAPA when detecting that CAPA during the time up to the completion of the pulling operation, and this causes a drawback of brining the pulling operation or process to be unstable within the DVD-RAM disk drive apparatus, etc.

Also, for example, in the following Patent Document 2, there is already known an optical disk player, wherein a mode is changed into a groove servo when conducting the land on the optical disk, and after detecting the groove close to a predetermined land, the mode mentioned above is exchanged into a land servo. And, in the following Patent Document 3 is also already known a land/groove detection device and a method for an optical disk apparatus, wherein detecting a transitional response of the tracking error signal for a predetermined time period, it is determined that the polarity of servo is different from the first one when the error signal increases, thereby exchanging the servo polarity so as to carry out the tracking. Furthermore, in the following Patent Document 4 is disclosed an optical disk apparatus, wherein detection is made on which side the tracking error signal has an offset, i.e., the positive polarity or the negative polarity, with respect to a level of the track center, and upon basis of that polarity, determination is made on which side of the track the optical spot should be pulled into, i.e., onto the land or the groove, so as to pull the optical spot onto the target, with stability, and thereby achieving the optical disk apparatus for enabling to shorten the time period for the pulling operation.

[Patent Document 1] Japanese Patent Laying-Open No. 2002-140824 (2002);

[Patent Document 2] Japanese Patent Laying-Open No. Hei 5-234111 (1993);

[Patent Document 3] Japanese Patent Laying-Open No. Hei 10-312547 (1998); and

[Patent Document 4] Japanese Patent Laying-Open No. 2000-187860 (2000).

### BRIEF SUMMARY OF THE INVENTION

As was mentioned above, with the conventional arts, in particular, with the Patent Document 1 mentioned above, although it pointed out the drawback that detection of the CAPA, up to the time period of completing the pulling operation in the seek operation, results into generation of the noises on the tracking error (TE) signal at that CAPA, and this brings the pulling process within the DVD-RAM drive apparatus into unstable in the condition thereof; however, as a means for dissolving such the problem, it only proposes to start the pulling operation within 0.4 ms after passing the CAPA, by adopting a CAPA detection process therein, for emphasizing the tracking error signal through differentiating process thereof through a high (frequency) bypass filter.

However, with such the conventional art, it still has the following drawback. Thus, since the high-bypass filter is necessary to differentiate the tracking error signal for the purpose of emphasizing thereof, it brings about an increase of costs on the side of the disk recording/reproducing apparatus, and further on the side of the DVD-RAM, as was mentioned above, the track is exchanged between the land and the groove, every one (1) round thereof, and in particular if conducting the pulling process in a front of the exchange portion, in many cases, it is impossible to read out a PID, i.e., being a physical address of the disk, before passing through the exchanging portion; therefore, there are cases where the polarity of the tracking servo cannot be reversed when passing through the exchange portion, and so that the tracking servo comes or jumps off.

Then, according to the present invention, being accomplished by taking the problems in the conventional arts mentioned above into the consideration thereof, and object thereof is to provide a seek control method, without necessity of providing such the high-bypass filter or the like, and in particular, enabling to perform the pulling operation onto the track after the seek operation stably, by taking the passing over the exchange portion on the optical disk into the consideration thereof, and thereby achieving the pulling operation onto the track with certainty, through reading the PID therein, and also to provide an optical disk recording/reproducing apparatus adopting such the method therein.

For accomplishing such object as was mentioned above, according to the present invention, there is provided a seek control method for use in an optical disk recording/reproducing apparatus, for moving an optical spot onto an arbitrary track, by moving the optical spot into a radial direction of an optical information recording medium, which is formed with lands and grooves, spirally, on an information recording surface thereof, comprising the following steps of: calculating time from staring of seek operation up to completion of pulling the optical spot onto a target track; calculating an amount of rotation of said optical information recording medium within the time, which is calculated in the above; determining on whether the pulling operation can be conducted or not within a pulling escape region on a land/groove exchange portion of a tack on the information recording surface of said optical information recording medium, upon the amount of rotation which is calculated in the above; and changing a starting position of said pulling operation so that said pulling operation can be executed escaping from said pulling escape region, upon basis of result of said determination.

Further, according to the present invention, the seek control method as described in the above, preferably further comprises the following step of: memorizing a generation timing of the land/groove exchange portion of the track on the information recording surface, from a signal generated in synchronism with rotation of said optical information recording medium, wherein said determination on whether the pulling operation can be conducted or not within the pulling escape region on the land/groove exchange portion of the tack on the information recording surface of said optical information recording medium, upon said generation timing memorized in the above, or preferably, said pulling escape region is set within a region including about four (4) sectors before and/or after said land/groove exchange portion, or preferably, said pulling escape region is to be about a half round on periphery of said optical information recording medium. Further, preferably, staring timing of the seek operation when changing the starting portion of said pulling operation.

In addition to the above, according to the present invention, there is further provided an optical disk recording/reproducing apparatus, enabling to load an optical information recording medium therein, which forms a track, spirally, with lands and grooves on the information recording surface, comprising: a driver for rotationally driving said information recording medium; an optical pickup, being disposed opposing to the information recording surface of said information recording medium, which is rotationally driven by said driver, to be movable in a radial direction thereof; a pickup driver for driving said optical pickup; and a system controller for driving at least said driver and said pickup driver of said apparatus, wherein said controller includes: a portion for calculating time from staring of seek operation up to completion of pulling the optical spot onto a target track; a portion for calculating an amount of rotation of said optical information recording medium within the time, which is calculated in the above; a portion for determining on whether the pulling operation can be conducted or not within a pulling escape region on a land/groove exchange portion of a tack on the information recording surface of said optical information recording medium, upon the amount of rotation which is calculated in the above; and a portion changing a starting position of said pulling operation so that said pulling operation can be executed escaping from said pulling escape region, upon basis of result of said determination, whereby conducting the seek operation through controlling said driver and said pickup driver of said apparatus.

Further, according to the present invention, the optical disk recording/reproducing apparatus as described in the above, preferably further comprises a portion for generating a signal in synchronism with rotation of said optical information recording medium, and wherein said determination portion determines on whether the pulling operation can be conducted or not within the pulling escape region on the land/groove exchange portion of the tack on the information recording surface of said optical information recording medium, makes, upon said signal generated in synchronism with the rotation, or preferably, said pulling escape region is set within a region including about four (4) sectors before and/or after said land/groove exchange portion, or preferably, said pulling escape region is to be about a half round on periphery of said optical information recording medium. Further, preferably, within the optical disk recording/reproducing apparatus as described in the above staring timing of the seek operation when changing the starting portion of said pulling operation.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an outline structure of an optical disk recording/reproducing apparatus, according to an embodiment of the present invention;

FIG. 2 is a view for explaining the structures on an information recording surface of an optical disk, onto/from which recording/reproducing can be made by means of the optical disk recording/reproducing apparatus;

FIG. 3 is a view for showing track traversing operation of an optical spot, during the seek operation within the optical disk recording/reproducing apparatus, and also a relationship between a FG signal accompanying therewith;

FIG. 4 is a view for showing an example of relationship between a number of tracks, on which the optical spot traverses, and a time period necessary at that instance, being applied within the seek control method according to the present invention; and

FIG. 5 is a flowchart for explaining the details of the seek control method according to the present invention mentioned above.

### DETAILED DESCRIPTION OF THE INVENTION

Hereinafter, embodiments according to the present invention will be fully explained by referring to the attached drawings.

First of all, FIG. 1 is a view for showing an outline structures of an optical disk recording/reproducing apparatus, according to a first embodiment of the present invention, and it is a block diagram, in particular, mainly for showing the constituent elements therein, so as to practice the seek control method, according to the present invention.

In the figure, a reference numeral 100 depicts an optical information recording medium, on the recording surface of which lands and grooves are formed in a spiral manner, such as, DVD-RAM, for example, representatively. This disc-like information recording medium, i.e., an optical disk is installed or loaded onto a holding member, such as, a turntable, etc., for example, which is attached at a tip of a rotation shaft of a spindle motor 101. On the other hand, this spindle motor 101 is rotationally driven, through a predetermined control method, by means of a spindle motor drive means 121, and at the same time, it outputs a signal, i.e., so-called a “FG” signal, which is made of a predetermined number of pulse signals per one (1) rotation thereof (for example, twelve (12) pieces of pulse signals), for indicating the rotational position thereof.

On the other hand, opposing the information recording surface (i.e., the lower surface in the figure) of the optical disk 100, being rotationally driven at a predetermined rotation speed, in this manner, there is provided an optical pickup 110, being movable in the radial direction of that optical disk 100. This optical pickup 110 irradiates a laser beam, which is generated from a light source provided therein, i.e., a laser light source 111 made up with a semiconductor later, for example, through an optical system including an objective lens, upon the information recording surface of the optical disk 100 mentioned above. On the other hand, a reflection light thereof is incident upon an optical detector 114, which is made up with photo transistors, etc., for example, passing through the optical system including the objective lens 113 mentioned above. The photo detector 114, receiving the reflection light from the information recording surface of the optical disk 100, converts the light into an electric signal, and thereby outputting the electric signal therefrom. Further, an error signal produce means 122 in the figure, inputting the signal outputted from that optical pickup 110, produces so-called a tracking error signal (i.e., a TE signal), to be supplied to a system control means 120, which is constructed with a CPU (a central processing unit) included therein.

And, inputting the tracking error signal (i.e., the TE signal) from the error signal produce means 122 and executing a predetermined process thereupon, the system control means 120 provides a tracking drive signal to an actuator drive means 123, as an output thereof, and further a motor drive signal to the spindle motor drive means 121 mentioned above, as well. This actuator drive means 123 is constructed with, such as, a driver circuit for use of controlling the spindle motor, included therein. Also, as was mentioned above, FIG. 1 shows only an outline structure of the optical disk recording/reproducing apparatus, mainly including the elements for practicing the seek control method, and therefore other elements are not shown in the figure; however, it is also apparent, in the similar manner, for the person skilled in the art, that signals supplied from necessary elements are inputted therein, so as to be executed with predetermined processes thereupon, and that necessary control signals are outputted therefrom to the necessary constituent elements.

Also, the optical pickup 110 mentioned above is movable into the radial direction of the disc-like optical disk, through a driving mechanism not shown in the figure (including a motor, sliding rails, and rack and pinion gears, etc., for example), and further the objective lens 113 thereof is also movable into the direction perpendicular to the information recording surface of the optical disk 100 mentioned above, through an actuator (including, voice coils, etc., for example) shown by a reference numeral 112 in the figure. And, the actuator drive means 123 controls the driving mechanism and the actuators, appropriately. Thus, within the optical disk recording/reproducing apparatus, the structures of which were explained in the above, while inputting the tracking error signal (i.e., the TE signal) from the error signal produce means 122, etc., the system control means 120 outputs tracking drive signals, and thereby executing the seek operation through movement of the optical pickup 110 by means of the actuator drive means 123 mentioned above, or in more details through moving an optical spot thereof into the radial direction of the optical disk.

Next, explanation will be made below upon the seek control method to be executed within the optical disk recording/reproducing apparatus mentioned above, according to the present invention.

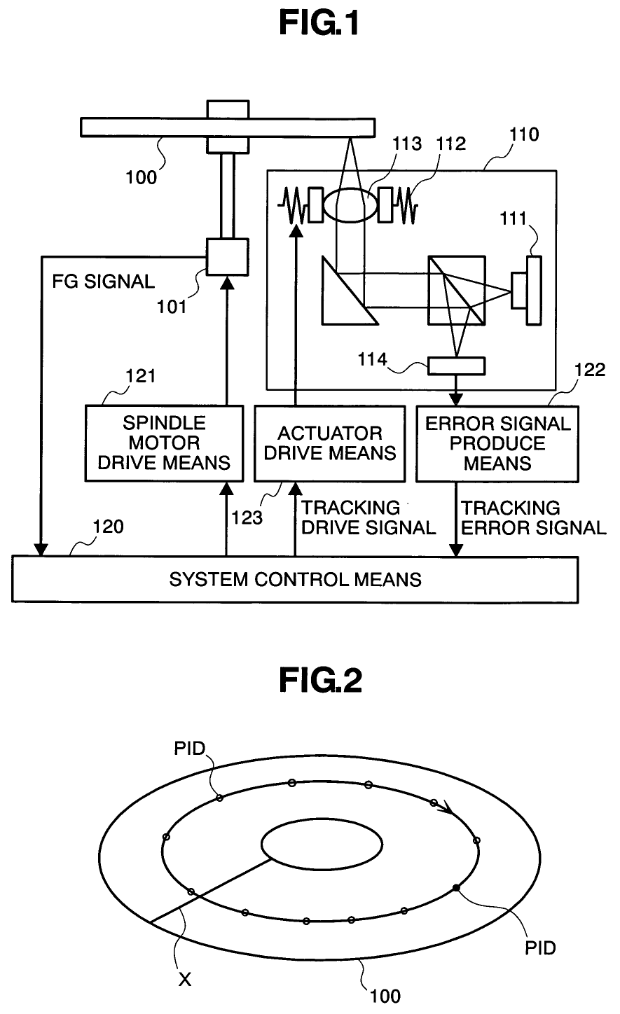

First, FIG. 2 attached herewith shows the optical information recording medium (i.e., the optical disk), onto/from the information recording surface of which information can be recorded/reproduced by means of the optical recording/reproducing apparatus according to the present invention, such as, DVD-RAM, for example, adopting a single track format therein; i.e., the spirally-formed land or the groove appears, alternately, for each one (1) round of rotation thereof. And, as is shown in the figure, on the surface of the disc-like information recording surface are formed so-called Land/Groove exchange portions X, in the radial direction thereof, where the land and the groove are changed over with each other. Also, on each track (i.e., the land or the groove), there is provided pits, which are called by “PID”, for indicating the physical position information of each sector.

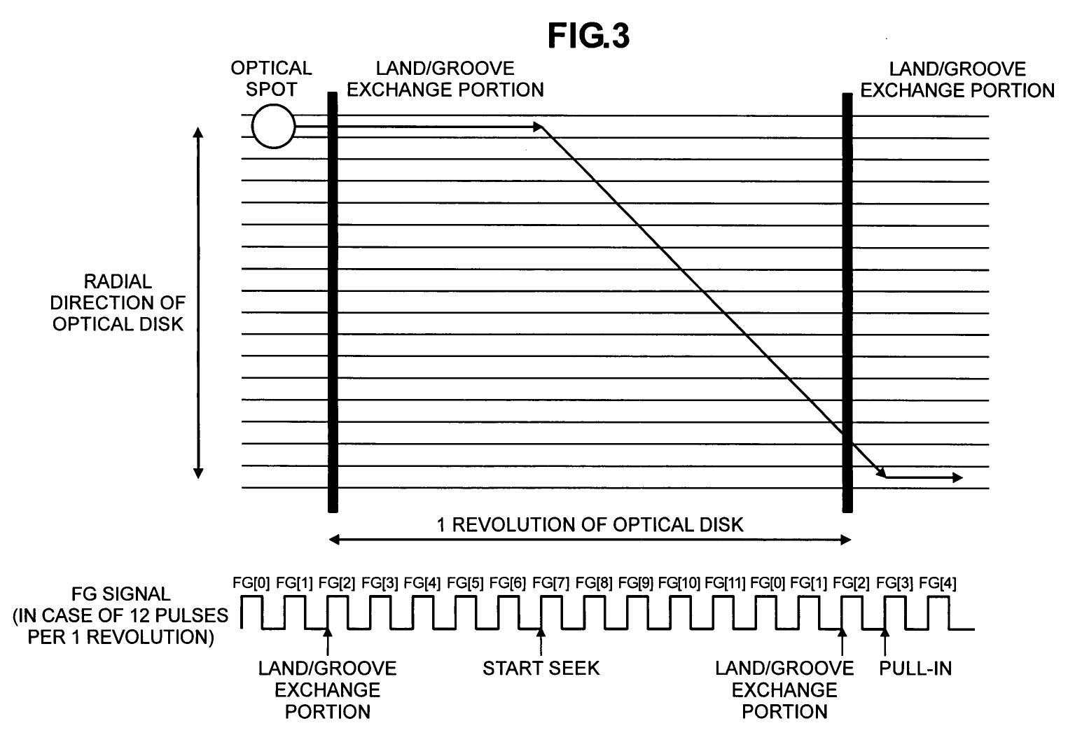

Also, FIG. 3 attached herewith shows the view of the optical disk 100 mentioned above, extending the spirally formed land and the groove thereof into a plane. And, when performing the seek operation for exchanging the track (i.e., from the land to the groove, or from the groove to the land), as is shown by an arrow in the figure, the optical spot of the optical pickup 110 (shown by “0” in the figure) is moved into the radial direction of the disk, i.e., it moves towards a target track while traversing the tracks, and it is pulled into the target track. Further, in a lower portion of the figure are shown waveforms of the FG signals (i.e., twelve (12) pieces of pulse signals per one (1) round of rotation), which are outputted from the spindle motor 101 in this instance, and in this example, it can be seen that the Land/Groove exchange portion appears per every one (1) round of revolution of the optical disk and that the timing thereof is in synchronism with FG (2) of the FG signal, in particular, in the present one. In other words, it is possible to detect the generation timing of the Land/Groove exchange portion X, through observation of the FG signal mentioned above.

Following to the above, explanation will be made on the operations in case when the seek operation is requested from an outside, for example, within the optical disk recording/reproducing apparatus, the structures of which are explained in the above.

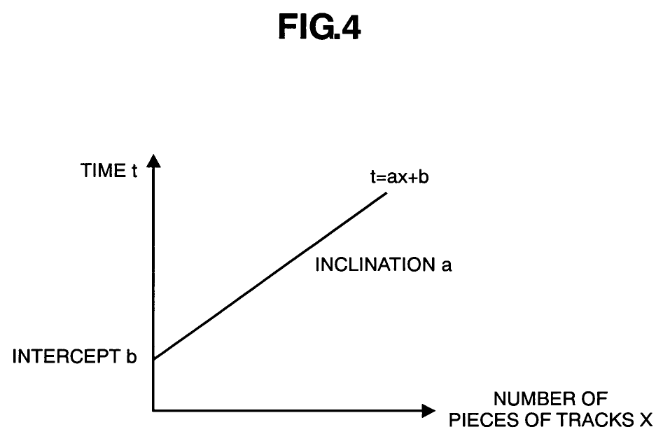

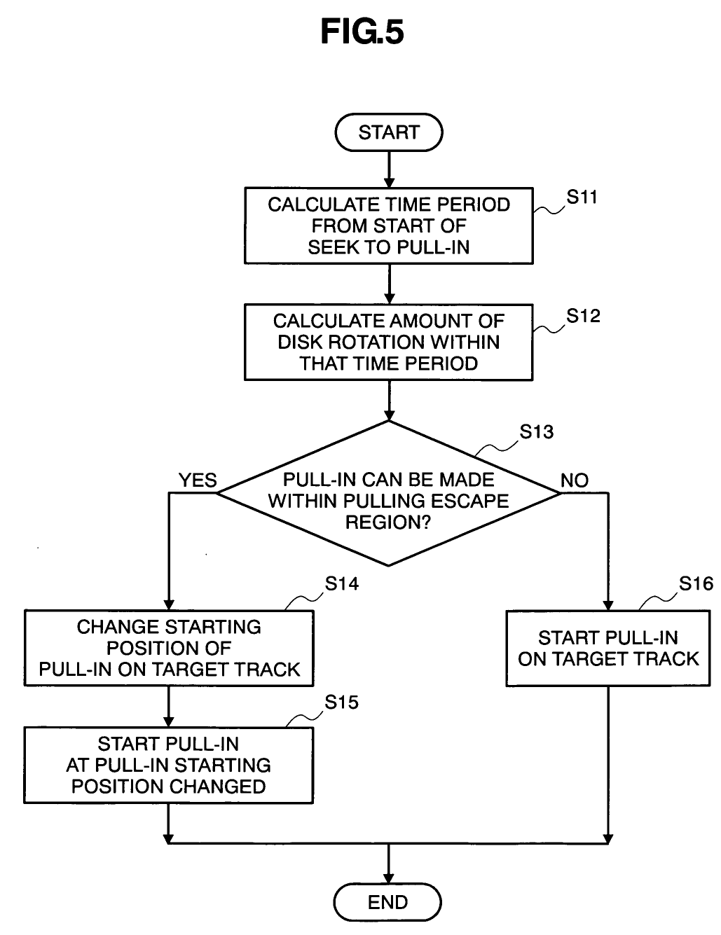

However, within an inside of the optical disk recording/reproducing apparatus, such as, into a memory of the CPU, building up the system control means 120 mentioned above, for example, there is recorded a relationship in advance, between the number of tracks across which the optical spot should move and the time period necessary for that instance. As an example of such the relationship, the following relationship equation is recorded into the apparatus, in case when it can be expressed by the following linear equation as shown in FIG. 4 attached herewith:
T=ax+b
where “a” in this equation indicates an inclination of the straight line, and “b” an intercept of that straight line. And, this equation can be set up or established, in advance, through calculations on a stage of designing and/or measurement on the actual apparatus, for example.

Also, when the disk is loaded or inserted into the apparatus, the system control means 120 memorizes the position of the Land/Groove exchange portion X where the land and the groove switch over to each other, in the form of a timing of generation of the FG signal, which is outputted in synchronism with rotation of the spindle motor (for example, please see FG (2) in case of FIG. 3 mentioned above), as was mentioned above, in advance, into the memory of the CPU, for example.

And, when the seek operation is requested from an outside, the process shown in FIG. 5 attached herewith will be executed. Thus, the process is started upon the request of the seek operation mentioned above, and at first, it calculates out the time period necessary for completing the pulling operation (i.e., pull-in) on to the target track (please see “PULL-IN” in FIG. 3) from starting of the seek operation (please see “START SEEK” in FIG. 3), with using the relationship equation memorized in advance, as was mentioned above (S11). Next, it obtains an amount of rotation of the disk to be rotated during that time period, which is calculated out in the above, from the rotation speed of the disk (S12). Further, the rotation speed of the disk can be obtained from the spindle motor control means 121 mentioned above or the FG signal.

Following the above, from the amount of rotation obtained in the above, it is determined on whether the pulling of the seek operation can be conducted or not (S13), within a predetermined region after passing through the Land/Groove exchange portion (i.e., a pulling (or pull-in) escape region). However, in this instance, it is possible to determine (or predict) the timing of the Land/Groove exchange portion, which is generated per one (1) revolution of the disk, as was mentioned above, from the memorized timing of generation of the FG signal, such as, the FG (2) in the example mentioned above, for example.

And, as a result of the determination (S13) mentioned above, if it is determined (or predicted) that the pulling operation will be conducted within an inside of the pulling (or pull-in) escape region (“YES”), the timing of starting the seek operation is changed. Thus, the position of starting the pulling operation is changed in such a manner that the pulling operation be conducted outside that pulling (or pull-in) escape region (S14). For example, the start timing of the seek operation is changed so that the pulling operation can be started at a sector position (i.e., PID) of the sector, which will appears late, on the same track (i.e., the groove or the land). However, the pulling operation is started at the start position of pulling operation that was changed, thereafter (S15).

Thus, according to the present invention, after conducting the pulling onto the track, the optical spot is prevented from rushing into the Lana/Groove exchange portion before recognizing the PID. The reason of this lies in that, although the polarity of the tracking servo must be reversed at the Land/Groove exchange portion, however it is impossible to obtain the timing for reversing in case when no PID can be readout. Also, since the track is already determined, onto which the optical spot should move, and it also must enter into the pulling operation just after reaching to that track, this is for the purpose of adjusting the position for starting the pulling operation, by shifting the timing for staring the pulling operation, but rather than chaining the destination to be pulled into.

On the other hand, as a result of the determination (S13) mentioned above, when determining that the pulling operation cannot be executed within an inside of the pulling (or pull-in) escape region (thus, it will be conducted outside that escape region), the process starts the pulling operation on the target track (S16) as it is, as is shown in the figure, thereby completing the series of processes.

However, upon the result of experiments, which are made by the inventors of the present invention, although depending on sensitivity of the optical pickup and/or the rotation speed of the disk, in general, but it can be seen that PID, i.e., the physical address of the sector can be read out, with almost certainty, by setting the predetermined region after passing through the Land/Groove exchange portion (i.e., the pulling (or pull-in) escape region) mentioned above to be within a region from 3 to 4 sectors. Thus, it is desired to enter into the pulling operation onto the track just after the exchange portion, inherently, but according to the present invention, about four (4) sectors before/after the exchange portion are adopted to be so-called a margin. However, the region (i.e., the pulling (or pull-in) escape region) should not be restricted as such. For example, depending on the apparatus, this region (i.e., the pulling (or pull-in) escape region) should be set from 10 to 15 sectors or more or less, in some cases, and further, in case when taking the fact that the sector number of the optical disk is around 25 on the innermost periphery into the consideration, it is preferable to set the region (i.e., the pulling (or pull-in) escape region) to be about a half round of the disk just before that the Land/Groove exchange portion, for the purpose preventing the optical spot from getting out from the tracking servo when it passes through the Land/Groove exchange portion, with more certainty.

Further, as to the margin, it is also preferable to set the about four (4) sectors after the exchange portion, to be such the escape region. Or, alternately, it is also possible to set the pulling (or pull-in) escape region mentioned above at an optimal number or value, with using the learning control, for example. In such the instance, it is desirable to reduce the number thereof, from the maximum pulling (or pull-in) escape region mentioned above, gradually, by a unit of the sector, thereby obtaining the optimal setup value.

As was apparent from the above, with the optical disk recording/reproducing apparatus, according to the present invention, in particular, the seek control method thereof, it is possible to pull the optical spot onto the target track, with certainty, after passing through the exchange portion between the land and the groove on the recording surface of the optical disk, and thereby to read out the sector position (i.e., the PID), with certainty, before the next Land/Groove exchange portion. For this reason, it is possible to prevent the optical spot from being swung off (or getting out) from the tracking servo.

As was mentioned above, according to the present invention, it is possible to achieve superior effects, such as, providing the seek control method enabling to achieve the pulling operation of an optical spot onto the track, with certainty, while conducting it stably by taking the passing over the exchange portion into the consideration thereof, but without necessity of providing such the high-bypass filter or the like, and also applying such the method therein, thereby providing an optical disk recording/reproducing apparatus having superior seek function therewith.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A seek control method for use in an optical disk recording/reproducing apparatus, for moving an optical spot onto an arbitrary track, by moving the optical spot into a radial direction of an optical information recording medium, which is formed with lands and grooves, spirally, on an information recording surface thereof, comprising the following steps of:
calculating time from staring of seek operation up to completion of pulling the optical spot onto a target track;
calculating an amount of rotation of said optical information recording medium within the time, which is calculated in the above;
determining on whether the pulling operation can be conducted or not within a pulling escape region on a land/groove exchange portion of a tack on the information recording surface of said optical information recording medium, upon the amount of rotation which is calculated in the above; and
changing a starting position of said pulling operation so that said pulling operation can be executed escaping from said pulling escape region, upon basis of result of said determination.

2. The seek control method, as described in the claim 1, further comprising the following step of:
memorizing a generation timing of the land/groove exchange portion of the track on the information recording surface, from a signal generated in synchronism with rotation of said optical information recording medium, wherein said determination on whether the pulling operation can be conducted or not within the pulling escape region on the land/groove exchange portion of the tack on the information recording surface of said optical information recording medium, upon said generation timing memorized in the above.

3. The seek control method, as described in the claim 1, wherein said pulling escape region is set within a region including about four (4) sectors before and/or after said land/groove exchange portion.

4. The seek control method, as described in the claim 1, wherein said pulling escape region is to be about a half round on periphery of said optical information recording medium.

5. The seek control method, as described in the claim 1, wherein staring timing of the seek operation when changing the starting portion of said pulling operation.

6. An optical disk recording/reproducing apparatus, enabling to load an optical information recording medium therein, which forms a track, spirally, with lands and grooves on the information recording surface, comprising:
a driver for rotationally driving said information recording medium;
an optical pickup, being disposed opposing to the information recording surface of said information recording medium, which is rotationally driven by said driver, to be movable in a radial direction thereof;
a pickup driver for driving said optical pickup; and
a system controller for driving at least said driver and said pickup driver of said apparatus, wherein said controller includes:
a portion for calculating time from staring of seek operation up to completion of pulling the optical spot onto a target track;
a portion for calculating an amount of rotation of said optical information recording medium within the time, which is calculated in the above;
a portion for determining on whether the pulling operation can be conducted or not within a pulling escape region on a land/groove exchange portion of a tack on the information recording surface of said optical information recording medium, upon the amount of rotation which is calculated in the above; and
a portion changing a starting position of said pulling operation so that said pulling operation can be executed escaping from said pulling escape region, upon basis of result of said determination, whereby conducting the seek operation through controlling said driver and said pickup driver of said apparatus.

7. The optical disk recording/reproducing apparatus, as described in the claim 6, further comprising a portion for generating a signal in synchronism with rotation of said optical information recording medium, and wherein said determination portion determines on whether the pulling operation can be conducted or not within the pulling escape region on the land/groove exchange portion of the tack on the information recording surface of said optical information recording medium, makes, upon said signal generated in synchronism with the rotation.

8. The optical disk recording/reproducing apparatus, as described in the claim 6, wherein said pulling escape region is set within a region including about four (4) sectors before and/or after said land/groove exchange portion.

9. The optical disk recording/reproducing apparatus, as described in the claim 6, wherein said pulling escape region is to be about a half round on periphery of said optical information recording medium.

10. The optical disk recording/reproducing apparatus, as described in the claim 6, wherein staring timing of the seek operation when changing the starting portion of said pulling operation.
